(19) United States
(12) Patent Application Publication
(10) Pub. No.: US 2008/0073326 A1
(43) Pub. Date: Mar. 27, 2008

(54) Ablative Circuit Interruption Device

(76) Inventors: Thangavelu Asokan, Bangalore (IN); Sunil Srinivasa Murthy, Bangalore (IN); Kunal Ravindra Goray, Bangalore (IN); Adnan Kutuhuddin Bohori, Anjaneya Temple (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/533,804

(22) Filed: Sep. 21, 2006

(51) Int. Cl. H01H 9/44

(52) U.S. Cl. 218/35

(57) ABSTRACT

An arc suppression insert (10) for a circuit breaker (e.g., includes an ablative body (12) defining a chamber (14) configured for receiving a pair of electrical contacts (16, 18) therein. The chamber is configured for accommodating movement of the electrical contacts from a closed state (20) to an open state (22). The chamber also includes a vent (24) through the ablative body for venting ablation vapors produced in the chamber responsive to an electrical arc (28) being generated between the electrical contacts when moving from the closed state to the open state effective to reduce a pressure in the chamber.

### FIELD OF THE INVENTION

Embodiments of the present invention are generally related to ablative circuit interruption devices, and, more particularly, to an ablative arc suppression insert comprising a vent for venting ablation vapors.

### BACKGROUND OF THE INVENTION

A variety of devices are known for interrupting current between a source and a load. Circuit breakers are one type of device designed to trip upon occurrence of heating or over-current conditions. Such devices typically include one or more moveable contacts that separate from mating contacts to interrupt a current carrying path. The devices may be single phase or include multiple phase sections for interrupting current through parallel current paths, such as in three phase applications.

Performance of a circuit interrupter is typically dictated by a peak let through current, which is in turn controlled by a rate of arc voltage development across the contacts as the contacts are moved away from one another during a circuit interruption event. Accordingly, circuit interrupter performance has focused on more rapidly increasing arc voltage development to limit a peak let-through current. One technique used to limit the let-through energy is to provide arc dissipating structures, such as plates arranged with air gaps between each plate, commonly known as an arc chute. Entry of the arc into such structures may assist in extinguishing the arc and thereby limit the let-through energy during circuit interruption. Another arc dissipating technique includes the use of ablative materials disposed proximate the contacts of the circuit interrupter. During an arcing event, some of the ablative material is vaporized by the arc. The resulting ablation vapors interact with the arc to absorb the arcing energy, resulting in lower arc temperatures and dissipation of the arc.

### BRIEF DESCRIPTION OF THE INVENTION

In an example embodiment, the invention includes an arc suppression insert for a circuit breaker. The insert includes an ablative body defining a chamber configured for receiving a pair of electrical contacts therein and for accommodating movement of the electrical contacts from a closed state to an open state. The chamber further includes a vent through the ablative body for venting ablation vapors produced in the chamber responsive to an electrical arc being generated between the electrical contacts when moving from the closed state to the open state effective to reduce a pressure in the chamber.

In another example embodiment, the invention includes an arc suppression insert for a circuit breaker. The insert includes an ablative body defining a chamber configured for receiving a pair of electrical contacts therein and for accommodating movement of the electrical contacts from a closed state to an open state. The chamber also includes a plurality of holes through the ablative body for venting ablation vapors produced in the chamber responsive to an electrical arc being generated between the electrical contacts when moving from the closed state to the open state effective to reduce a pressure in the chamber.

In another example embodiment, the invention includes a circuit breaker having a pair of electrical contacts and an arc suppression insert defining a chamber configured for receiving the contacts therein. The chamber is configured for accommodating movement of the contacts from a closed state to an open state. The chamber further includes a vent through the ablative body for venting ablation vapors produced in the chamber responsive to an electrical arc being generated between the electrical contacts when moving from the closed state to the open state effective to reduce a pressure in the chamber.

### BRIEF DESCRIPTION OF THE DRAWINGS

FIG. 1 shows a perspective view of an example embodiment of an ablative arc suppression insert.

FIG. 2 shows a cross sectional view of the example embodiment of the insert of FIG. 1 viewed from a front side along line 2-2.

FIG. 3 shows a perspective view of an example embodiment of an ablative arc suppression insert.

FIG. 4 shows a cross sectional view of an example embodiment of the insert of FIG. 1 viewed along line 4-4.

FIG. 5 shows a cross sectional view of an example embodiment of an ablative arc suppression insert.

FIG. 6 shows a cross sectional view of an example embodiment of an ablative arc suppression insert.

FIG. 7 shows a cross sectional view of an example embodiment of an ablative arc suppression insert.

FIG. 8 shows a cross sectional view of an example embodiment of an ablative arc suppression insert.

FIG. 9 shows a cross sectional view of an example embodiment of an ablative arc suppression insert.

FIG. 10 shows a perspective view of an example embodiment of an ablative arc suppression insert.

FIG. 11 shows a perspective view of an example embodiment of an ablative arc suppression insert.

FIG. 12 shows a perspective view of an example embodiment of an ablative arc suppression insert.

FIG. 13 shows a cross sectional view of the example embodiment of the insert of FIG. 12 viewed along line 13-13.

FIG. 14 shows a perspective view of a plurality of the ablative arc suppression inserts of FIG. 1 installed in respective arc chambers of a partially disassembled three phase circuit breaker.

FIG. 15 shows a graph of let through energy versus phase angle for a three phase breaker having arc chutes compared to let through current versus phase angle for a three phase breaker having example ablative arc suppression inserts.

### DETAILED DESCRIPTION OF THE INVENTION

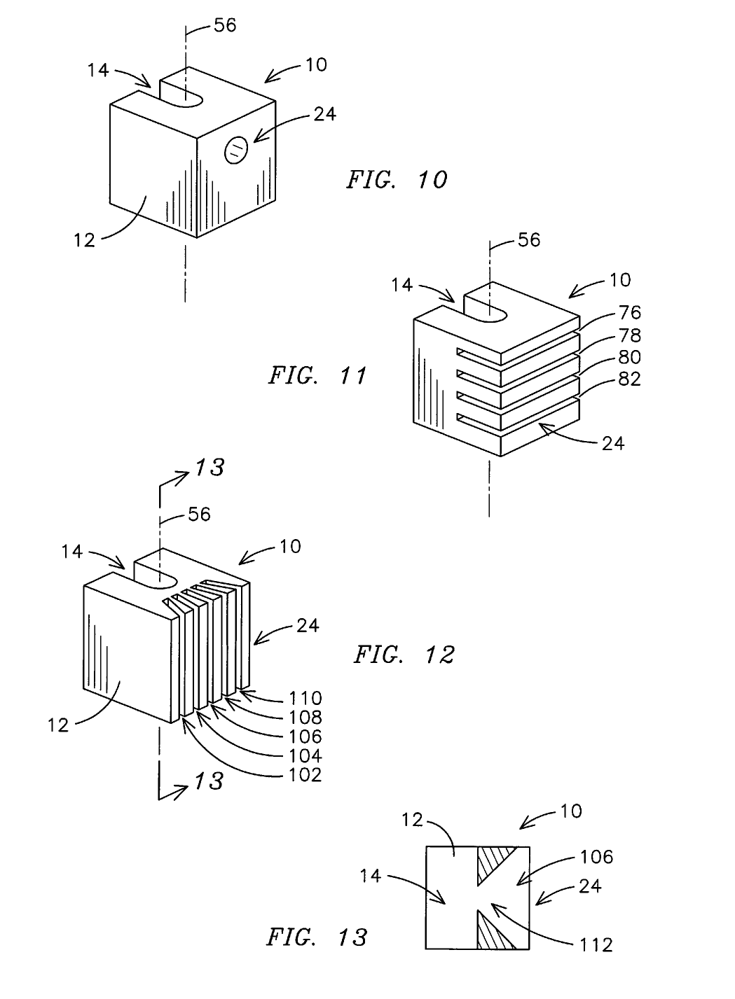

The inventors have innovatively recognized that it may be advantageous to confine an arc generated between two separating electrical contacts in arc confinement region using ablative material to achieve sufficient arc suppression, for example, without the need for an arc chute. Although the inventors have determined that arc suppression is more effective when closely confining the arc, such close confinement may produce concentrated ablative vapors in the confinement region that may limit interaction between the arc and the ablative. In addition, accumulation of ablation vapors may also result in elevated pressure in the arc confinement region. For example, it has been experimentally observed that high vapor pressures, such as vapor pressures above 100 bars, resulting from ablation in a confined region may limit arc cooling, resulting in undesirably longer arc extinguishing times. Such elevated vapor pressure may result from a choked exhaust flow condition wherein ablation vapors may not be evacuated sufficiently quickly from the confined region. Elevated vapor pressure in the confinement region may increase a temperature in the chamber and reduce arc quenching performance. Accordingly, the inventors have developed a vented arc suppression insert 10, for example, as shown in FIG. 10, comprising an ablative body 12 defining a chamber 14 for confining an arc to achieve arc energy absorption. The chamber 14 includes a vent 24 for directing ablation vapors away from the chamber 14. Advantageously, the insert 10 may be retrofitted into arc chambers of existing circuit breaker designs that previously accommodated arc chutes in their arc chambers.

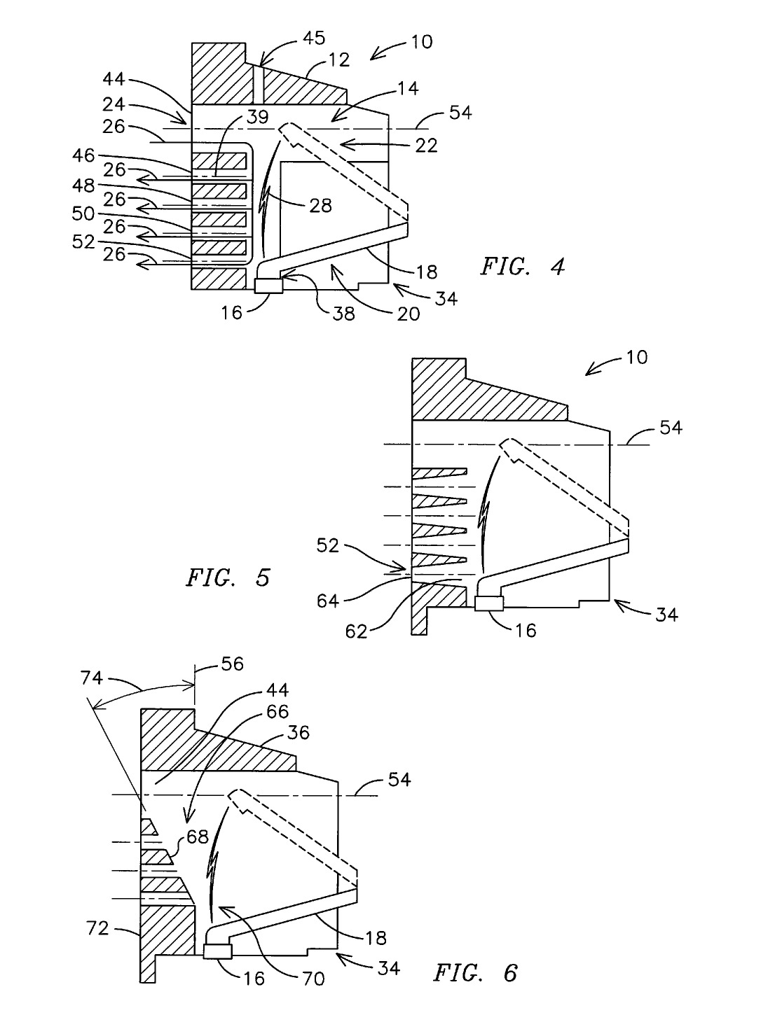

FIG. 1 shows a perspective view of an example embodiment of an ablative arc suppression insert 10 and FIG. 4 shows a cross sectional view of the insert of FIG. 1 viewed from along line 4-4. The insert 10 includes an ablative body 12 defining a chamber 14 configured for receiving a pair of electrical contacts 16, 18 therein and for accommodating movement of at least one of the electrical contacts 16, 18 from a closed state 20 to an open state 22. One, or both, contacts 16, 18 may be movable out of contact with the other contact 18, 16 during a circuit interruption event.

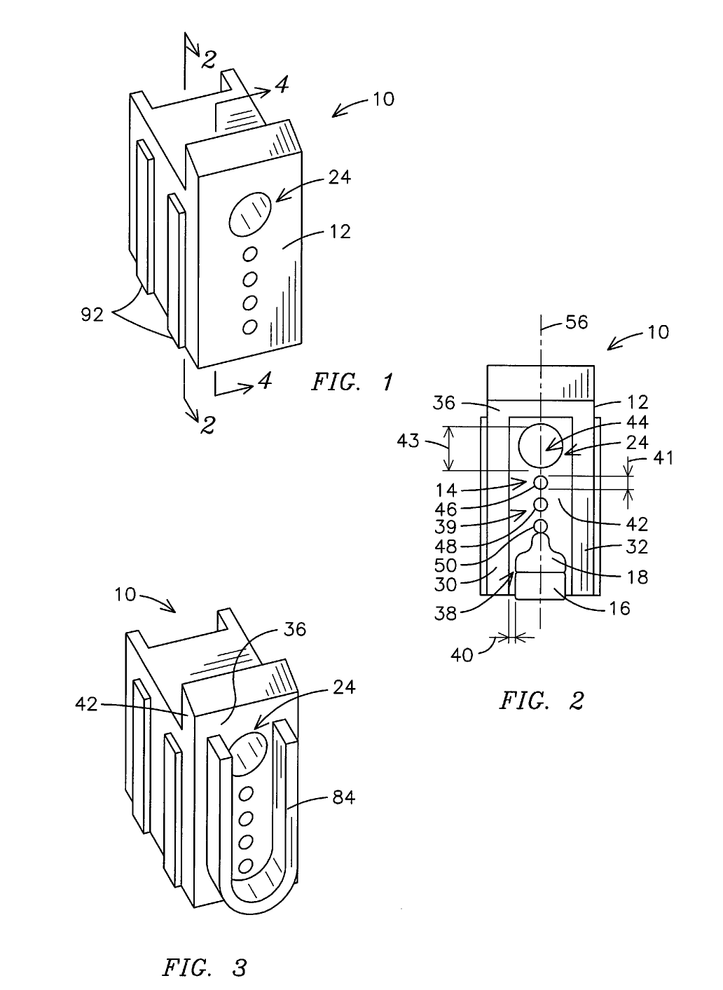

As shown in the cross-sectional view of FIG. 2, the insert 10 may include a top wall 36, a rear wall 42, and a pair of spaced apart side walls 30, 32 for defining the chamber 14. The chamber 14 may include an opening 34 for receiving contacts 16, 18. The opening 34 may be configured for positioning the ablative body 12 over the contacts 16, 18 and for allowing movement of one, or both, of the contacts 16, 18 from the closed state 20 to the open state 22. In an embodiment, the side walls 30, 32 may be spaced away from the contacts 16, 18 proximate a contact point 38 by a distance of about 0.5 millimeters (mm) to 10 mm. It has been experimentally determined that this spacing range provides sufficient ablative arc cooling for prospective current up to about 150 kiloamperes (kA), whereas a spacing greater than about 10 mm may not provide sufficient arc cooling. However, for relatively higher prospective current breakers, and/or circuit breakers having multiple-fingered contacts, a spacing greater then 10 mm may provide sufficient ablative arc cooling.

As shown in FIGS. 1, 2, and 4, the arc suppression insert 10 includes an ablative body 12 defining a chamber 14 that includes a vent 24. The vent 24 may be configured for venting ablation vapors 26 produced in the chamber 14 responsive to an electrical arc 28 being generated between the electrical contacts 16, 18 when the contacts 16, 18 move from the closed state 20 to the open state 22. The vent 24 conducts the ablation vapors 26 away from the chamber 14, thereby limiting a pressure increase in the chamber 14 due to generation of ablation vapors during arcing. In an embodiment, the vent 24 may be configured for conducting a sufficient amount of ablation vapor away from the chamber 14 to limit a pressure in the chamber 14 to less than about 100 bars. In another embodiment, the vent 24 may be configured for conducting a sufficient amount of ablation vapor away from the chamber 14 to limit a pressure in the chamber 14 to less than about 75 bars. In yet another embodiment, the vent 24 may be configured for conducting a sufficient amount of ablation vapor away from the chamber 14 to limit a pressure in the chamber 14 to less than about 60 bars. The vent 24 may include an opening, such as a hole 45 or slot through the top wall 36 of the chamber 14 and/or a opening such as a hole 44 or slot through the rear wall 42 of the chamber 14. Although vents configured as circular holes are shown in FIGS. 1, 2, and 4, the vent 24 may be configured in any geometrical shape for venting vapors from the chamber 14.

In an example embodiment shown in FIG. 2, the vent 24 may include a plurality of holes 44, 46, 48, 50 through the rear wall 42. The locations of the holes 44, 46, 48, 50 may be aligned with a vertical axis 56 of the chamber 14 along the rear wall 42. The holes 44, 46, 48, 50 may be sized to provide desired levels of ablative vapor venting from portions of the chamber in communication with the respective holes. In an example embodiment, at least one of the holes 44, 46, 48, 50 may be sized larger than other holes, such as the hole 44 disposed proximate the top wall 36 of the chamber 14. For example, hole 44 may have a larger diameter 43 than a diameter 41 of hole 46.

As shown in FIG. 4, a horizontal axis, e.g. 39, of one or more of holes e.g. 46, may be aligned in parallel with a horizontal axis 54 of the insert 10. In another example embodiment shown in FIG. 7, horizontal axes 39, 37, 35, 33 of respective holes 46, 48, 50, 52 may be angled with respect to the horizontal axis 54 of the insert 10. For example, holes 46, 48, 50, 52 may be angled so that respective outlets 45, 47, 49, 51 of the holes 46, 48, 50, 52 are further away from a bottom 13 of the insert 10 than their respective inlets 53, 55, 57, 59. In an example embodiment, horizontal axes 39, 37, 35, 33 of respective holes 46, 48, 50, 52 may be angled with respect to the horizontal axis 54 at angle 58 of about 0 degrees to about 60 degrees.

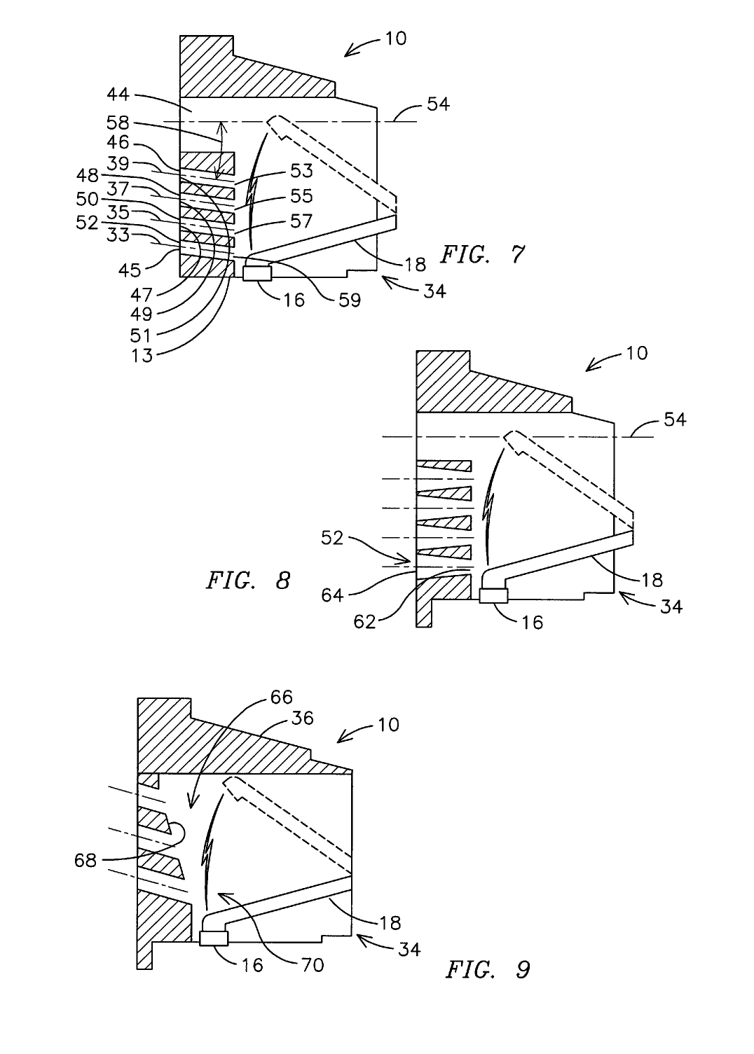

In other example embodiments shown in FIGS. 5 and 8, at least one of the holes includes an inlet opening larger than a corresponding outlet opening. For example, hole 52 of FIG. 5 may include an inlet opening 62 larger than a corresponding outlet opening 64. In another aspect shown in FIG. 8, at least one of the holes includes an inlet opening smaller than a corresponding outlet opening. For example, hole 52 of FIG. 8 includes an inlet opening 62 smaller than a corresponding outlet opening 64.

In other example embodiments shown in FIGS. 6 and 9, the chamber 14 of the insert 10 may include an enlarged region 66 disposed proximate the top wall 36 of the chamber 14. The enlarged region 66 may be defined by a sloped portion 68 of the rear wall 42 of the chamber 14. As shown in FIG. 9, the sloped portion 68 may extend rearwardly away from an arc confining region 70 defined by a bottom portion 72 of the rear wall 42 proximate the contacts 16, 18 when the contacts 16, 18 are in the closed state 20 to a point proximate the top wall 36 of the insert 10. In another exemplary embodiment shown in FIG. 6, the sloped portion 68 may extend from the arc confining region 70 to a topmost hole, for example, hole 44. The sloped portion 68 may be angled rearwardly with respect to the vertical axis 56 of the insert 10 at an angle 74 of about 0 degrees to about 60 degrees. Other geometric configurations may also be used to provide an enlarged region 66 above the arc confining region 70, for example, to provide an increased volume in the chamber 14 away from an arc confining region 70 to allow ablation vapors to expand therein.

FIGS. 10-12 show perspective views of other example embodiments of an ablative arc suppression insert. In FIG. 10, the vent 24 includes a slot oriented with respect to the vertical axis 56 of the chamber 14. In FIG. 11, the vent 24 comprises a plurality of slots 76, 78, 80, 82. The slots 76, 78, 80, 82 may be oriented perpendicularly with respect to the vertical axis 56 of the chamber 14. In FIG. 12 the vent 24 may include a plurality of slots 102, 104, 106, 108, 110. The slots 102, 104, 106, 108, 110 may be oriented parallel with respect to the vertical axis 56 of the chamber 14. In another example embodiment, the slots 102, 104, 106, 108, 110 may extend radially away from the vertical axis 56 of the chamber 14. As shown in the cross sectional view of FIG. 13, the slots, such as slot 106, may include a neck-down region 112 proximate the chamber 14.

In the example embodiment depicted in FIG. 3, the arc suppression insert 10 may include a vent exhaust directing structure 84, proximate an outlet of the vent 24 for directing ablation vapors away from the insert 10. The exhaust directing structure 84 may include a u-shaped wall extending outwardly from an outlet face 36 of the rear wall 42 of the insert 10.

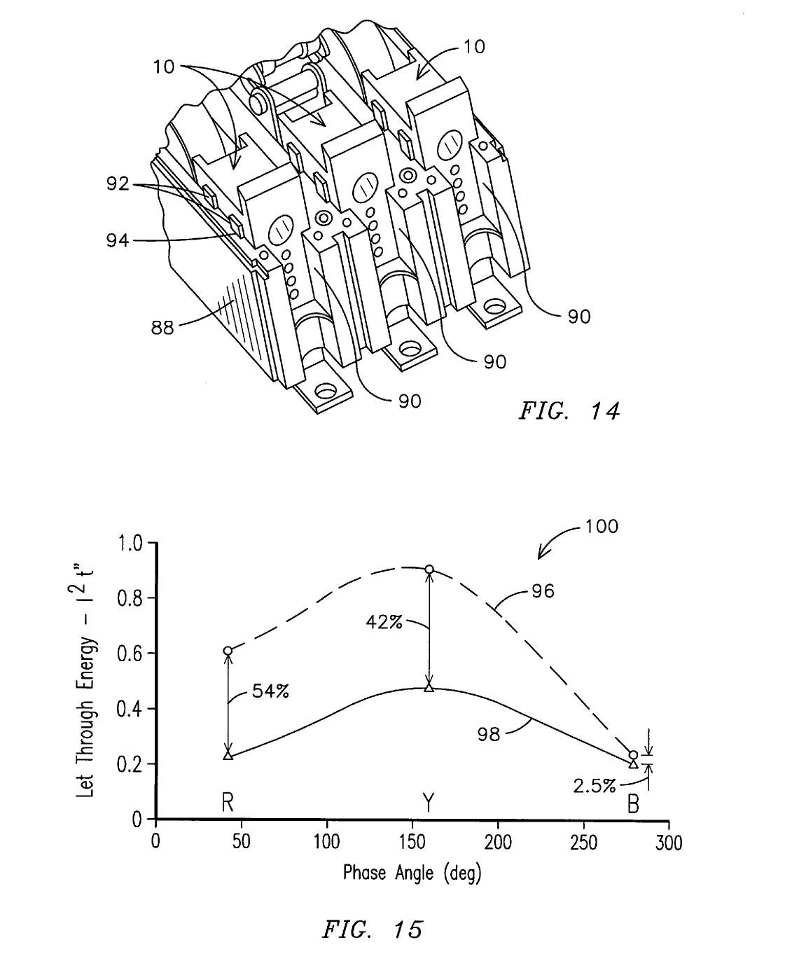

FIG. 14 shows a perspective view of a plurality of inserts 10 of FIG. 1 installed in respective arc chambers 90 of an exemplary three phase circuit breaker 88. The inserts 10 fit into the arc chamber 90 previously configured for housing an arc chute assembly (not shown). In an example embodiment, the body 12 of the insert 10 may include an outer surface shape configured for fitting the insert 10 into a respective arc chamber 90 of a circuit breaker 88, such as with a frictional or biased fit. Accordingly, existing circuit breaker designs may be retrofitted with the ablative insert 10. In an example embodiment of the invention, the outer surface shape of the insert 10 may include protuberances, such as ribs 92, that fit into corresponding slots 94 of a circuit breaker arc chamber 90.

Ablative materials such as polyoxymethylene, polymethylpentene, poly-methylacrylate, poly-amide, poly-butylene teraphthalate, polyester, and phenolic composite have been found to possess desired ablative characteristics for use in arc quenching. In particular, polymers such as DELRIN®, manufactured by E.I. du Pont de Nemours and Company, USA, and a phenolic composite known in the trade as HYLAM manufactured by Bakelite Hylam Limited, India, have been demonstrated to have desired ablation characteristics for use as a material for making the insert 10.

Table 1 below lists percentage improvement over an arc chute in Reducing Let-Through Current by using an arc ablative insert as described above in a circuit breaker, such as the configuration show in FIG. 14. As shown in table 1, use of a vented DELRIN® insert resulted in a 22% reduction in let-through current and use of a vented HYLAM insert resulted in an 8.5% reduction in let-through current.

TABLE 1
Improvement in Reducing Let-Through Current Using an Ablative
Insert Instead of an Arc Chute Assembly in a Circuit Breaker

| | | Improvement in |
|---|---|---|
| Arc Suppression | Let-Through Current | Reducing Let-Through |
| Medium | kA (Peak) | Current |
| Arc Chute | 11.71 | (reference) |
| DELRIN ® Ablative | 9.16 | 22% |
| HYLAM Ablative | 10.72 | 8.5% |

FIG. 15 shows a comparison graph 100 of let through energy versus phase angle for a three phase breaker having arc chutes 96 compared to a three phase breaker having example ablative arc suppression inserts 98, such as the three phase breaker configuration show in FIG. 14. The graph 100 depicts prospective currents, R/Y/B (rms), of 24.2/25.5/24.8 kiloamperes at 281/272/280 volts, respectively, at a firing angle of 45 degrees with respect to the R phase. As can be seen in the graph 100, let thought energy using an example ablative arc suppression insert as described above decreases let through energy by about 54% for the R phase, about 42% for the Y phase, and about 2.5% for the B phase.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An arc suppression insert for a circuit breaker comprising an ablative body defining a chamber configured for receiving a pair of electrical contacts therein and for accommodating movement of the electrical contacts from a closed state to an open state, wherein the chamber includes a a vent through the ablative body for venting ablation vapors produced in the chamber responsive to an electrical arc being generated between the electrical contacts when moving from the closed state to the open state effective to reduce a pressure in the chamber.

2. The arc suppression insert of claim 1, wherein the vent is configured for conducting a sufficient amount of ablation vapors away from the chamber to limit the pressure in the chamber to less than about 100 bars.

3. The arc suppression insert of claim 1, wherein the vent is configured for conducting a sufficient amount of ablation vapors away from the chamber to limit the pressure in the chamber to less than about 75 bars.

4. The arc suppression insert of claim 1, wherein the vent is configured for conducting a sufficient amount of ablation vapors away from the chamber to limit the pressure in the chamber to less than about 60 bars.

5. The arc suppression insert of claim 1, wherein the ablative body comprises a pair of spaced apart sidewalls and a rear wall.

6. The arc suppression insert of claim 5, wherein the ablative body comprises a top wall.

7. The arc suppression insert of claim 6, wherein the vent comprises a hole through the top wall.

8. The arc suppression insert of claim 5, wherein the vent comprises a hole through the rear wall.

9. The arc suppression insert of claim 8, wherein the vent comprises a plurality of holes.

10. The arc suppression insert of claim 9, wherein respective locations of the holes are aligned with a vertical axis of the chamber.

11. The arc suppression insert of claim 9, wherein the holes are sized to provide different levels of ablation vapor venting from portions of the chamber in communication with the respective holes.

12. The arc suppression insert of claim 9, wherein at least one of the holes is sized larger than other holes.

13. The arc suppression insert of claim 12, wherein the at least one of the holes sized larger than other holes is disposed proximate the top wall.

14. The arc suppression insert of claim 9, wherein a horizontal axis of at least one of the holes is angled with respect to a horizontal axis of the insert.

15. The arc suppression insert of claim 8, wherein the hole comprises an inlet opening larger than an outlet opening.

16. The arc suppression insert of claim 8, wherein the hole comprises an outlet opening larger than an inlet opening.

17. The arc suppression insert of claim 6, wherein the chamber comprises an enlarged region disposed proximate the top wall.

18. The arc suppression insert of claim 17, wherein the enlarged region is defined by a portion of the rear wall sloped away from a vertical axis of the chamber.

19. The arc suppression insert of claim 1, wherein the vent comprises at least one slot oriented parallel to a vertical axis of the chamber.

20. The arc suppression insert of claim 1, wherein the vent comprises a plurality of slots oriented parallel to a vertical axis of the chamber.

21. The arc suppression insert of claim 1, wherein the slots extend radially away from the vertical axis of the chamber.

22. The arc suppression insert of claim 1, wherein the vent comprises at least one slot oriented perpendicularly with respect to a vertical axis of the chamber.

23. The arc suppression insert of claim 5, wherein the sidewalls are spaced apart a distance sufficient for providing a spacing of about 0.5 millimeters to 10 millimeters away from contacts disposed between the walls.

24. The arc suppression insert of claim 1, further comprising an exhaust directing structure proximate an outlet of the vent for directing ablation vapors away from the insert.

25. The arc suppression insert of claim 1, wherein the body comprises an outer surface shape configured for fitting the insert into an arc chamber of a circuit breaker.

26. An arc suppression insert for a circuit breaker comprising:
an ablative body defining a chamber configured for receiving a pair of electrical contacts therein and for accommodating movement of the electrical contacts from a closed state to an open state; wherein the chamber includes a plurality of holes through the ablative body for venting ablation vapors produced in the chamber responsive to an electrical arc being generated between the electrical contacts when moving from the closed state to the open state effective to reduce a pressure in the chamber.

27. A circuit breaker comprising:
a pair of electrical contacts; and
an arc suppression insert having an ablative body comprising a pair of spaced apart sidewalls, a rear wall, and a top wall defining a chamber configured for receiving the contacts therein and for accommodating movement of the contacts from a closed state to an open state, wherein the wherein the chamber includes a vent through the ablative body for venting ablation vapors produced in the chamber responsive to an electrical arc being generated between the electrical contacts when moving from the closed state to the open state effective to reduce a pressure in the chamber.
